(19) United States
(12) Patent Application Publication
(10) Pub. No.: US 2023/0153591 A1
(43) Pub. Date: May 18, 2023

(54) SEMICONDUCTOR DEVICE, METHOD OF OPERATING SEMICONDUCTOR DEVICE, AND SEMICONDUCTOR SYSTEM

(71) Applicant: SAMSUNG ELECTRONICS CO., LTD., SUWON-SI (KR)

(72) Inventors: SE WHAN NA, Suwon-si (JP); UNKI PARK, Suwon-si (JP); JIHEON OK, Suwon-si (JP); JOOYOUNG AN, Suwon-si (KR); HYUNWOOK LIM, Suwon-si (KR)

(21) Appl. No.: 18/050,699

(22) Filed: Oct. 28, 2022

(30) Foreign Application Priority Data
Nov. 15, 2021 (KR) 10-2021-0157109
May 11, 2022 (KR) 10-2022-0058034

(51) Int. Cl. G06N 3/063; G06N 3/04

(52) U.S. Cl. CPC G06N 3/063; G06N 3/04

(57) ABSTRACT

The described techniques provide efficient semiconductor device configurations and improved processes for facilitating artificial intelligence operations. In an example, a semiconductor device may be configured with first memory for storing data before an artificial intelligence operation and second memory for storing data after an artificial intelligence operation. The use of the first memory and the second memory for storing data before and after the artificial intelligence operation, respectively, may support a simplified layout for a semiconductor device to facilitate artificial intelligence operations with minimal hardware configurations and limited software. In addition, the use of the first memory and the second memory for storing data before and after the artificial intelligence operation, respectively, may allow for processing when the domains of input data and output data are different.

### CROSS-REFERENCE TO RELATED APPLICATION

This application claims priority to and the benefit of Korean Patent Application No. 10-2021-0157109 filed in the Korean Intellectual Property Office on Nov. 15, 2021 and Korean Patent Application No. 10-2022-0058034 filed in the Korean Intellectual Property Office on May 11, 2022, the entire contents of which are incorporated by reference herein.

### BACKGROUND

### (a) Field

The present disclosure relates to a semiconductor device, a method of operating the semiconductor device, and a semiconductor system.

### (b) Description of the Related Art

Neural networks (e.g., artificial neural networks) may refer to computer models (e.g., statistical learning algorithms) inspired by processes in biology and cognitive science, such as biological neural network processes. An artificial neural network may include multiple nodes (e.g., artificial neurons) that form a network through weighted connections between different pairs of nodes. For instance, the weight connections may be similar to synaptic bonding in biological neural networks where different synapses may have different bonding strengths. The weighed connections of an artificial neural network may be adjusted through learning to produce desired outputs and solve various problems (e.g., may be used in various applications of machine learning).

An algorithm using an artificial neural network may be performed by using a general-purpose processor such as a graphics processing unit (GPU) or a neural processing unit (NPU). A NPU may include (e.g., or refer to) a microprocessor that specializes in the acceleration of machine learning algorithms. For example, an NPU may operate on predictive models such as artificial neural networks or random forests (RFs).

In some cases, an NPU may be designed in a way that makes the NPU inefficient (e.g., or unsuitable) for general purpose computing (e.g., compared to a Central Processing Unit (CPU)). Additionally, or alternatively, software support for an NPU may not be developed for general purpose computing. Accordingly, improved processing and storage techniques that efficiently leverage neural network technologies may be desired.

### SUMMARY

One or more aspects of the present disclosure describe a semiconductor device, a method of operating the semiconductor device, and a semiconductor system that may utilize hardware dedicated to artificial intelligence computation that may operate even in an environment in which resources are limited.

According to one or more aspects of the present disclosure, a semiconductor device may include: an operator performing an artificial intelligence operation; a first memory and a second memory each configured to store feature map data used in the artificial intelligence operation; and a third memory configured to store a training parameter used in the artificial intelligence operation, wherein the operator may use, for a neural network layer, the first memory and the second memory as a first space for storing data before the artificial intelligence operation and a second space for storing data after the artificial intelligence operation, respectively.

In some embodiments, the operator may read the feature map data stored in the first memory for a first neural network layer to perform the artificial intelligence operation; and may store an operation result of the artificial intelligence operation in the second memory.

In some embodiments, the operator may read the feature map data stored in the second memory for a second neural network layer following the first neural network layer to perform the artificial intelligence operation; and may store an operation result of the artificial intelligence operation in the first memory.

In some embodiments, the operator may divide the artificial intelligence operation into a data fetch step, a multiplication step, an accumulation step, and a write memory step; and may perform the data fetch step, the multiplication step, the accumulation step, and the write memory step using pipelining.

In some embodiments, when the feature map data includes N rows and M columns, and when the neural network layer corresponds to a column layer, the operator may perform the write memory step once whenever performing the data fetch step, the multiplication step, and the accumulation step N times, wherein N is an integer greater than or equal to two, and M is an integer greater than or equal to two.

In some embodiments, when the feature map data includes N rows and M columns, and when the neural network layer corresponds to a row layer, the operator may perform the write memory step once whenever performing the data fetch step, the multiplication step, and the accumulation step M times, wherein N is an integer greater than or equal to two, and M is an integer greater than or equal to two.

In some embodiments, the semiconductor device may further include a pre-processor configured to perform pre-processing on input data from one or more domains for the artificial intelligence operation, and provide the pre-processed data to the first memory or the second memory.

In some embodiments, the semiconductor device may further include a post-processor configured to perform post-processing on output data from the artificial intelligence operation and provide the post-processed data to one or more domains.

In some embodiments, the operator may include a first operator that performs a first artificial intelligence operation and a second operator that performs a second artificial intelligence operation different from the first artificial intelligence operation, and the first operator may use, for the neural network layer, a partial area of the first memory and a partial area of the second memory as a third space for storing data before the first artificial intelligence operation and a fourth space for storing data after the first artificial intelligence operation, respectively.

In some embodiments, the second operator may use, for the neural network layer, another partial area of the first memory and another partial area of the second memory as a fifth space for storing data before the second artificial intelligence operation and a sixth space for storing data after the second artificial intelligence operation.

One or more aspects of the present disclosure provide a method of operating a semiconductor device, including: providing feature map data including N rows and M columns to a first memory, wherein N is an integer greater than or equal to two, and M is an integer greater than or equal to two; reading the feature map data stored in the first memory and performing a first artificial intelligence operation on a first column to an M-th column of the feature map data; writing a result of the first artificial intelligence operation to a second memory; reading feature map data stored in the second memory and performing a second artificial intelligence operation on a first row to an N-th row of the feature map data; and writing a result of the second artificial intelligence operation to the first memory.

In some embodiments, the performing of the first artificial intelligence operation may include performing a data fetch step, a multiplication step, an accumulation step, and a write memory step using pipelining, and in this case, performing the write memory step once whenever the data fetch step, the multiplication step, and the accumulation step are performed N times for one column of the first column to the M-th column.

In some embodiments, the performing of the second artificial intelligence operation may include performing a data fetch step, a multiplication step, an accumulation step, and a write memory step using pipelining, and in this case, performing the write memory step once whenever the data fetch step, the multiplication step, and the accumulation step are performed M times for one row of the first row to the N-th row.

In some embodiments, the method of operating the semiconductor device may further include, performing pre-processing on input data from one or more domains for the first artificial intelligence operation, and providing the pre-processed data to the first memory or the second memory.

In some embodiments, the method of operating the semiconductor device may further include, performing post-processing on output data from the second artificial intelligence operation and providing the post-processed data to one or more domains.

One or more aspects of the present disclosure provide a semiconductor system, including: a display driver configured to drive a display panel based on input image data; a touch controller configured to convert a touch sensing signal received from a touch sensor into touch sensing data; a host processor configured to provide the input image data to the display driver and receive the touch sensing data from the touch controller; and an artificial intelligence unit configured to perform an artificial intelligence operation generating predictive noise data corresponding to the input image data, wherein the artificial intelligence unit includes: an operator configured to perform the artificial intelligence operation; a first memory and a second memory each configured to store feature map data used in the artificial intelligence operation; and a third memory configured to store a training parameter used in the artificial intelligence operation, and the operator uses, for a neural network layer, the first memory and the second memory as a first space for storing data before the artificial intelligence operation and a second space for storing data after the artificial intelligence operation, respectively.

In some embodiments, the artificial intelligence unit may be installed in one of the display driver, the touch controller, and the host processor.

In some embodiments, the operator may divide the artificial intelligence operation into a data fetch step, a multiplication step, an accumulation step, and a write memory step, and may perform the data fetch step, the multiplication step, the accumulation step, and the write memory step using pipelining.

In some embodiments, when the feature map data includes N rows and M columns and when the neural network layer corresponds to a column layer, the operator may perform the write memory step once whenever performing the data fetch step, the multiplication step, and the accumulation step N times, wherein N is an integer greater than or equal to two, and M is an integer greater than or equal to two.

In some embodiments, when the feature map data includes N rows and M columns, and when the neural network layer corresponds to a row layer, the operator may perform the write memory step once whenever performing the data fetch step, the multiplication step, and the accumulation step M times, wherein N is an integer greater than or equal to two, and M is an integer greater than or equal to two.

In some embodiments, the semiconductor system may further include a pre-processor configured to perform pre-processing on the input image data to provide it (e.g., the pre-processed input image data) to the first memory or the second memory.

In some embodiments, the semiconductor system may further include a post-processor configured to perform post-processing on the predictive noise data to provide it (e.g., the post-processed predictive noise data) to a compensation circuit that compensates for the touch sensing data.

One or more aspects of the present disclosure provide a semiconductor system, including: a first device and a second device that exchange data in a first domain; a third device and a fourth device that exchange data in a second domain different from the first domain; an artificial intelligence unit that performs an artificial intelligence operation on data in the first domain or data in the second domain; a first pre/post-processor that performs first pre-processing to provide the data of the first domain to the artificial intelligence unit or that performs first post-processing to provide an operation result of the artificial intelligence unit to the first domain; and a second pre/post-processor that performs second pre-processing to provide the data of the second domain to the artificial intelligence unit or that performs second post-processing to provide an operation result of the artificial intelligence unit to the second domain.

In some embodiments, the artificial intelligence unit may include: an operator performing an artificial intelligence operation; a first memory and a second memory that store feature map data used in the artificial intelligence operation; and a third memory that stores a training parameter used in the artificial intelligence operation, where the operator may use, for a neural network layer, the first memory and the second memory as a first space for storing data before the artificial intelligence operation and a second space for storing data after the artificial intelligence operation, respectively.

In some embodiments, the operator may divide the artificial intelligence operation into a data fetch step, a multiplication step, an accumulation step, and a write memory step, and may perform the data fetch step, the multiplication step, the accumulation step, and the write memory step using pipelining.

In some embodiments, when the feature map data includes N rows and M columns, and when the first neural network layer corresponds to a column layer, the operator may perform the write memory step once whenever performing the data fetch step, the multiplication step, and the accumulation step N times, wherein N is an integer greater than or equal to two, and M is an integer greater than or equal to two.

In some embodiments, when the feature map data includes N rows and M columns, and when the neural network layer corresponds to a row layer, the operator may perform the write memory step once whenever performing the data fetch step, the multiplication step, and the accumulation step M times, wherein N is an integer greater than or equal to two, and M is an integer greater than or equal to two.

In some embodiments, the operator may include a first operator that performs a first artificial intelligence operation and a second operator that performs a second artificial intelligence operation different from the first artificial intelligence operation, and the first operator may use, for the neural network layer, a partial area of the first memory and a partial area of the second memory as a third space for storing data before the first artificial intelligence operation and a fourth space for storing data after the first artificial intelligence operation, respectively.

In some embodiments, the second operator may use, for the neural network layer, another partial area of the first memory and another partial area of the second memory as a fifth space for storing data before the second artificial intelligence operation and a sixth space for storing data after the second artificial intelligence operation.

One or more aspects of the present disclosure provide a method, including: performing pre-processing on data of a first domain; storing the pre-processed data in first memory for an artificial intelligence operation; performing the artificial intelligence operation on the pre-processed data stored in the first memory; storing an operation result of the artificial intelligence operation in second memory; and performing post-processing on the operation result to provide the operation result to a second domain, wherein the data of the first domain has a higher resolution and a lower refresh rate than the operation result of the second domain.

### BRIEF DESCRIPTION OF THE DRAWINGS

FIG. 1 and FIG. 2 illustrate block diagrams of a semiconductor system according to one or more aspects of the present disclosure.

FIG. 3 and FIG. 4 illustrate methods of operating a semiconductor device according to one or more aspects of the present disclosure.

FIG. 5 to FIG. 7 illustrate methods of operating a semiconductor device according to one or more aspects of the present disclosure.

FIG. 8 to FIG. 10 illustrate methods of operating a semiconductor device according to one or more aspects of the present disclosure.

FIG. 11 and FIG. 12 illustrate block diagrams of a semiconductor system according to one or more aspects of the present disclosure.

FIG. 13 illustrates a block diagram of a semiconductor device according to one or more aspects of the present disclosure.

FIG. 14 illustrates a block diagram of a semiconductor system according to one or more aspects of the present disclosure.

FIG. 15 illustrates a block diagram of a semiconductor system according to one or more aspects of the present disclosure.

FIG. 16 illustrates a block diagram of a semiconductor system according to one or more aspects of the present disclosure.

### DETAILED DESCRIPTION OF THE EMBODIMENTS

Artificial intelligence techniques, such as machine learning, may include (e.g., or refer to) learning techniques in which a model for data analysis is automatically created such that software learns data and finds a pattern. Artificial intelligence techniques may be useful for solving various problems, and it may be appropriate to support these techniques in a wide range of operation environments. However, systems and environments implementing artificial intelligence techniques may have limited resources (e.g., limited hardware configurations, limited software, etc.). As a result, artificial intelligence techniques may be limited, reduced, or otherwise unavailable in such environments (e.g., and less effective techniques may be implemented, which may result in increased latency and power consumption).

The devices, systems, and techniques described herein generally improve resource utilization (e.g., via hardware dedicated to artificial intelligence computations, via pipelining techniques, via alternating usage of memory, etc.), such that artificial intelligence operations may be efficiently performed in resource limited environments. For example, one or more aspects of the present disclosure provide for efficient configurations of components on a semiconductor device, improved processes for facilitating artificial intelligence operations, etc. In an example, a semiconductor device may be configured with first memory for storing data before an artificial intelligence operation and second memory for storing data after an artificial intelligence operation. The use of the first memory and the second memory for storing data before and after the artificial intelligence operation, respectively, may support an improved layout for a semiconductor device to facilitate artificial intelligence operations with minimal hardware configurations and limited software. In addition, the use of the first memory and the second memory for storing data before and after the artificial intelligence operation, respectively, may allow for processing when the domains of input data and output data are different.

Various aspects of the present disclosure are described more fully herein with reference to the accompanying drawings, in which example embodiments of the present disclosure are shown. As those skilled in the art would realize, the described embodiments may be modified in various ways by analogy, all without departing from the spirit or scope of the present disclosure.

Accordingly, the drawings and description are to be regarded as illustrative in nature and not restrictive. Like reference numerals designate like elements throughout the specification.

In addition, a singular form may be intended to include a plural form as well, unless an explicit expression such as “one” or “single” is used. Terms including ordinal numbers such as first, second, and the like may be used to describe various constituent elements and are not to be interpreted as limiting these constituent elements. These terms may be used to distinguish one constituent element from other constituent elements.

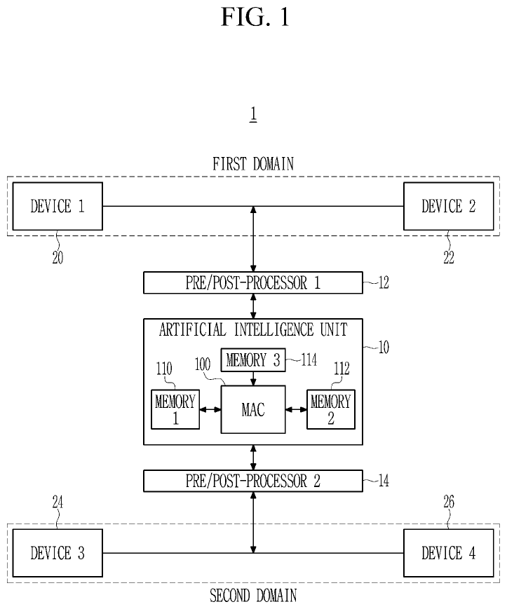

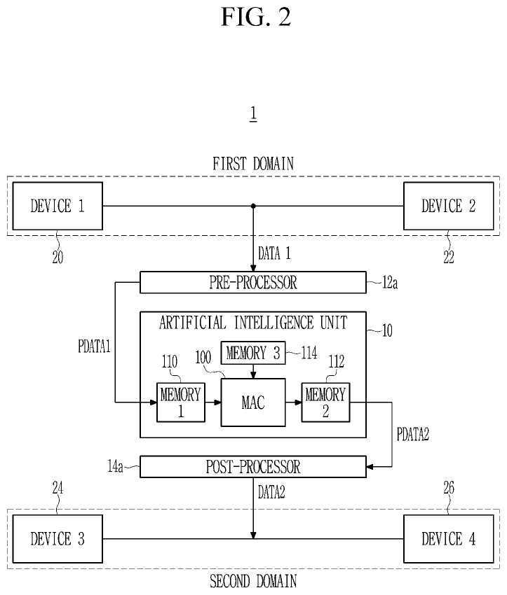

FIG. 1 and FIG. 2 illustrate block diagrams of a semiconductor system according to an embodiment.

Referring to FIG. 1, a semiconductor system 1 according to an embodiment may include an artificial intelligence unit 10, a first pre/post-processor 12, and a second pre/post-processor 14.

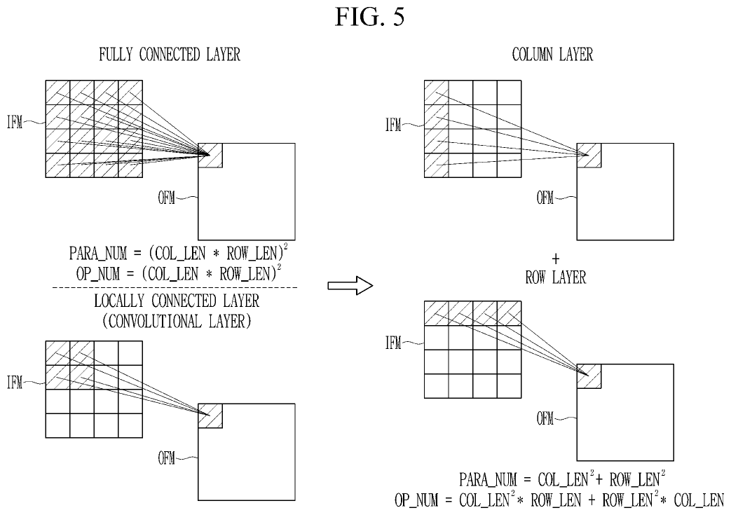

The artificial intelligence unit 10 may perform artificial intelligence operations. Specifically, the artificial intelligence unit 10 may perform an operation on adjacent elements in a feature map. For instance, an artificial intelligence operation may refer to an operation on adjacent elements in a feature map. A convolution operation may be an example of an artificial intelligence operation (e.g., performed by the artificial intelligence unit 10) and may include adding all values obtained by performing an elementwise multiplication of elements of a kernel with elements of an image (e.g., where the kernel overlaps with a portion of the image). In some examples, the artificial intelligence unit 10 may perform arbitrary artificial intelligence operations performed in a predetermined manner on other feature map data. For example, the artificial intelligence unit 10 may perform a column-direction operation or a row-direction operation on the feature map data, and details will be described later with reference to FIG. 5 to FIG. 7.

The artificial intelligence unit 10 may include an operator 100 (e.g., a multiplier accumulator (MAC) operator), a first memory 110, a second memory 112, and a third memory 114. The artificial intelligence unit 10 may perform artificial intelligence operations even in a limited environment in which a general-purpose processor such as a GPU or an NPU may be used.

The operator 100 may perform the aforementioned artificial intelligence operation. The operator 100 may also be referred to as a multiplier accumulator (MAC) operator. Specifically, the operator 100 may include a multiplier for performing multiplication, an accumulator for accumulating an operation result, a bit shifter for processing an activation function such as a rectified linear activation unit (ReLU), a clipper, and a lookup table (LUT), but the scope of the present disclosure is not limited to those listed.

The first memory 110 and the second memory 112 may store feature map data used for an artificial intelligence operation. In the present embodiment, the first memory 110 and the second memory 112 may be implemented as a static random-access memory (SRAM), but the scope of the present disclosure is not limited thereto.

Examples of a memory device may include random access memory (RAM), read-only memory (ROM), or a hard disk. Examples of memory devices include solid state memory and a hard disk drive. In some examples, memory may be used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

A processor may be an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor may be configured to operate a memory array using a memory controller. In other cases, a memory controller may be integrated into the processor. In some cases, the processor may be configured to execute computer-readable instructions stored in a memory to perform various functions. In some embodiments, a processor may include special purpose components for modem processing, baseband processing, digital signal processing, or transmission processing.

In some embodiments, the first memory 110 and the second memory 112 may store, for example, display image data, fingerprint on display (FOD) data, touch sensing data, camera image data, and the like. These data may have a constant spatial size (e.g., resolution, sampling grid, etc.), have a time interval (e.g., frame rate, scan rate, refresh rate), and may be data provided while being continuously changed.

The third memory 114 may store a training parameter used for an artificial intelligence operation. Here, the training parameter may include, for example, a weight used for the artificial intelligence operation. That is, the operator 100 may read the third memory 114 to obtain a training parameter and may perform an artificial intelligence operation by using the obtained training parameter. In the present embodiment, the third memory 114 may be implemented as an SRAM, but the scope of the present disclosure is not limited thereto.

The operator 100 may use the first memory 110 and the second memory 112 as a first space for storing data before an artificial intelligence operation and a second space for storing data after an artificial intelligence operation, respectively, for a neural network layer (e.g., for each neural network layer). Specifically, the operator 100 may read feature map data stored in the first memory 110 for a first neural network layer to perform an artificial intelligence operation, and then the operator 100 may store an operation result in the second memory 112. In addition, the operator 100 may read feature map data stored in the second memory 112 for a second neural network layer next to the first neural network layer to perform an artificial intelligence operation, and then the operator 100 may store an operation result in the first memory 110. In some examples, a neural network layer that is next to another neural network layer may receive input from the other neural network layer, send output to the other neural network layer, precede or follow the other neural network layer in an ordering of neural network layers, or a combination thereof.

Meanwhile, in the present embodiment, the semiconductor system 1 may further include a first device 20 and a second device 22 that exchange data in a first domain, and a third device 24 and a fourth device 26 that exchange data in a second domain different from the first domain (e.g., where the first domain and the second domain may include, or refer to, different bandwidth domains, different dynamic range domains, etc.). For example, data transmitted in the first domain and data transmitted in the second domain may have one or more of: different bandwidths, different dynamic ranges, etc.

The semiconductor system 1 may use the pre/post-processors 12 and 14 to perform an artificial intelligence operation between different domains.

The first pre/post-processor 12 may perform first pre-processing to provide data of the first domain to the artificial intelligence unit 10. Here, the first pre-processing may include spatial pre-processing and temporal pre-processing. Examples of the spatial pre-processing may include scaling, local averaging, interpolation, cropping, and the like, and examples of the temporal pre-processing may include re-sampling, frame rate converting, and the like, but the scope of the present disclosure is not limited to the listed examples (e.g., and other examples may be implemented by analogy).

In addition, the first pre/post-processor 12 may perform first post-processing to provide the operation result of the artificial intelligence unit 10 to the first domain. Here, the first post-processing may mean an inverse transformation with respect to the pre-processing (e.g., the first pre-processing) described herein. For example, when the pre-processing is down-sampling for resolution, the post-processing may be up-sampling for the resolution (e.g., pixel data interpolation). As another example, when the pre-processing is down sampling for a refresh rate, the post-processing may be up-sampling for the refresh rate (e.g., frame data interpolation).

Up-sampling may refer to the process of resampling in a multi-rate digital signal processing system. Up-sampling can include expansion and filtering (i.e., interpolation). Up-sampling may be performed on a sequence of samples of a signal (e.g., an image), and may produce an approximation of a sequence obtained by sampling the signal at a higher rate or resolution. The process of expansion refers to the process of inserting additional data points (e.g., zeros or copies of existing data points). Interpolation refers to the process of smoothing out the discontinuities (e.g., with a lowpass filter). In some cases, the filter is called an interpolation filter.

Down-sampling may refer to the process of reducing samples (e.g., sample-rate reduction in a multi-rate digital signal processing system). Down-sampling can include compression and filtering (i.e., decimation). Down-sampling may be performed on a sequence of samples of a signal (e.g., an image), and may produce an approximation of a sequence obtained by sampling the signal at a lower rate or resolution. Compression may refer to decimation by an integer factor. For instance, decimation by a factor of 10 results in using (e.g., keeping, encoding, sampling, etc.) every tenth sample. The process of compression thus refers to the process of removing data points.

In addition, the first pre/post-processor 12 may use an LUT for performing scaling, shifting, min/max clipping, and non-linearity transformation in order to perform normalization for a dynamic range of a signal.

In some examples, the second pre/post-processor 14 may perform second pre-processing in order to provide the data of the second domain to the artificial intelligence unit 10 or may perform second post-processing in order to provide the operation result of the artificial intelligence unit 10 to the second domain. Here, for details of the second pre-processing and the second post-processing, reference may be made to the contents described herein (e.g., above) in relation to the first pre-processing and the first post-processing.

Referring to FIG. 2, in the semiconductor system 1, the artificial intelligence unit 10 may perform an artificial intelligence operation on data DATA1 of the first domain.

To this end, a pre-processor 12a may receive the data DATA1 of the first domain pre-process the data DATA1 to generate data PDATA1, and provide the data PDATA1 to the artificial intelligence unit 10.

The artificial intelligence unit 10 may store the data PDATA1 in the first memory 110. The operator 100 may perform an artificial intelligence operation on the data PDATA1 stored in the first memory 110 by using a weight parameter obtained by reading the third memory 114, and the operator 100 may store an operation result PDATA2 in the second memory 112.

A post-processor 14a may post-process the data PDATA2 stored in the second memory 112 to generate data DATA2 and may provide the data DATA2 to the second domain.

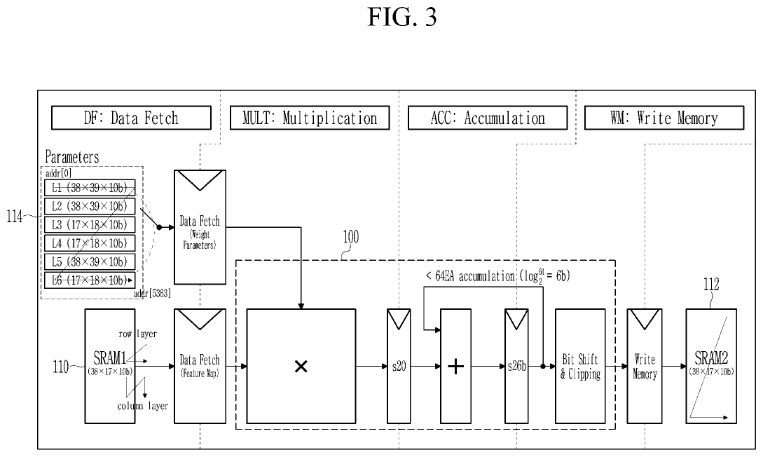

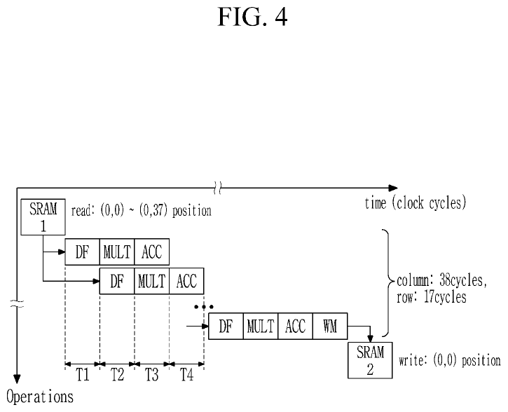

FIG. 3 and FIG. 4 respectively illustrate a method of operating a semiconductor device according to an embodiment.

Referring to FIG. 3, in the semiconductor device according to the embodiment, the operator 100 may divide the artificial intelligence operation into a data fetch DF step, a multiplication MULT step, an accumulation ACC step, and a write memory WM step, and may perform the corresponding steps (e.g., the data fetch DF step, the multiplication MULT step, the accumulation ACC step, and the write memory WM step) using pipelining. Performing steps using pipelining may refer to performing each step sequentially using a respective component of a sequence of components. The sequence of components may be able to operate or perform steps concurrently such that a first step may be performed on first data while a second step is being performed on second data.

The data fetch step may be a step of fetching the feature map data from the first memory 110 and fetching the weight parameter from the third memory 114, and the multiplication step may be a step of performing a multiplication operation on the feature map data (i.e., elements in the feature map) and the weight parameter. The accumulation step may be a step of accumulating the multiplication result, and the write memory step may be a step of writing the accumulated result to the second memory 112.

Referring to FIG. 4, in a first time period T1, feature map data corresponding to a first position on the first memory 110 may be fetched. In a second time period T2, multiplication of the feature map data corresponding to the first position and the weight parameter may be performed, and at the same time, feature map data corresponding to a second position on the first memory 110 may be fetched.

In a third time period T3, the operation results for the feature map data corresponding to the first position may be accumulated, and at the same time, the multiplication of the feature map data corresponding to the second position and the weight parameter may be performed, and at the same time, the feature map data corresponding to the third position on the first memory 110 may be fetched.

In a fourth time period T4, the operation results for the feature map data corresponding to the second position may be accumulated, and at the same time, the multiplication of the feature map data corresponding to the third position and the weight parameter may be performed, and at the same time, the feature map data corresponding to the fourth position on the first memory 110 may be fetched.

After the operation using pipelining described above is repeated a predetermined number of times, a step of writing the accumulated result to the second memory 112 may be performed.

FIG. 5 to FIG. 7 illustrate methods of operating a semiconductor device according to an embodiment.

An artificial neural network (ANN) is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting a maximum, or relative maximum, from the inputs as the output) or any other suitable algorithm for activating the node. Each node and edge may be associated with one or more node weights that determine how the signal is processed and transmitted.

During a training process, training parameters (e.g., node weights) may be adjusted to improve an accuracy of a result (i.e., by minimizing a loss function which corresponds in some way to a difference between a current result and a target result). The weight of an edge increases or decreases the strength of the signal transmitted between nodes. In some cases, nodes may have a threshold below which a signal may not be transmitted at all. In some examples, the nodes are aggregated into layers. Different layers perform different transformations on their inputs. An initial layer is known as an input layer and a last layer is known as an output layer. In some cases, signals traverse certain layers multiple times.

Referring to FIG. 5, the artificial neural network may include a fully-connected layer that performs operations on all elements of an input feature map IFM and weight parameters to generate respective elements of an output feature map OFM. The fully-connected layer may have a plurality of weight parameters and a plurality of operations. For example, the number PARA_NUM of the weight parameters of the fully-connected layer may correspond to a square of a product of a column length COL_LEN and a row length ROW_LEN, and the number OP_NUM of the operations of the fully-connected layer may also correspond to the square of the product of the column length COL_LEN and the row length ROW_LEN.

Alternatively, the artificial neural network may include a locally-connected layer or a convolutional layer that performs operations on elements of an adjacent area of the input feature map IFM to generate respective elements of the output feature map OFM, so as to reduce the number PARA_NUM of the weight parameters and the number OP_NUM of the operations. In the locally-connected layer or the convolutional layer, only elements of the input feature map IFM adjacent to a first element may be considered in generating each element of the output feature map OFM.

Alternatively, the artificial neural network may include a column layer, receive column weight parameters, and generate the output feature map OFM by performing a column-direction operation on the input feature map IFM based on the column weights. For example, when the input feature map IFM has N rows (e.g., where N may be an integer greater than or equal to 1) and M columns (e.g., where M may be an integer greater than or equal to 1), the column layer may receive N\hat{ }2 column weights. That is, the number of the column weights may correspond to the square of the number of the rows (e.g., a square of a length of each column). In addition, the column layer may perform column-direction weighted sum operations using the column weights for respective columns of the input feature map IFM to generate a corresponding column of the output feature map OFM, and accordingly, it may generate an output feature map OFM having N rows and M columns.

Alternatively, the artificial neural network may include a row layer, receive row weight parameters, and generate the output feature map OFM by performing a row-direction operation on the input feature map IFM based on the row weights. For example, when the input feature map IFM has N rows and M columns, the row layer RL may receive M\hat{ }2 row weights. That is, the number of the row weights may correspond to the square of the number of the columns, that is, a square of a length of each row. In addition, the row layer may perform row-direction weighted sum operations using the row weights for respective rows of the input feature map IFM to generate a corresponding row of the output feature map OFM, and accordingly, it may generate an output feature map OFM having N rows and M columns.

Particularly, since the number PARA_NUM of the weight parameters of the column layer corresponds to the square of the row length ROW_LEN and the number PARA_NUM of the weight parameters of the row layer corresponds to the square of the column length COL_LEN, the number PARA_NUM of the weight parameters of the column layer and the row layer may correspond to the sum of the square of the column length COL_LEN and the square of the row length ROW_LEN, and may be smaller than the number PARA_NUM of the weight parameters of the fully-connected layer.

In addition, since the number OP_NUM of the operations of the column layer corresponds to the product of the square of the column length COL_LEN and the row length ROW_LEN and the number OP_NUM of the operations of the row layer corresponds to the product of the square of the row length ROW_LEN and the column length COL_LEN, the number OP_NUM of the operations of the column layer CL and the row layer RL may correspond to the sum of the product of the square of the column length COL_LEN and the row length ROW_LEN and the product of the square of the row length ROW_LEN and the column length COL_LEN, and may be smaller than the number OP_NUM of the operations of the fully-connected layer.

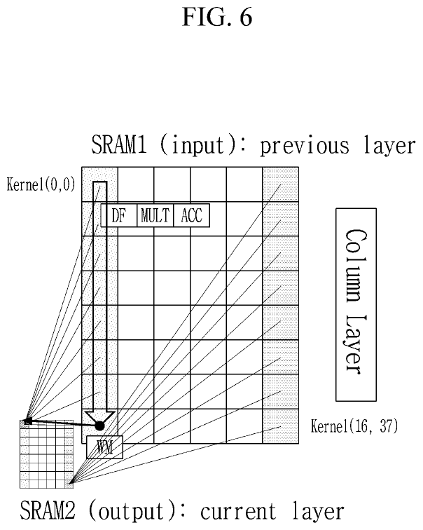

Referring to FIG. 6, when the feature map data includes N rows (e.g., where N may be an integer greater than or equal to 2) and M columns (e.g., where M may be an integer greater than or equal to 2), and the first neural network layer corresponds to the column layer, the operator 100, whenever performing the data fetch step, the multiplication step, and the accumulation step N times on the input feature map IFM read from the first memory 110, may perform the write memory step to the second memory 112 once.

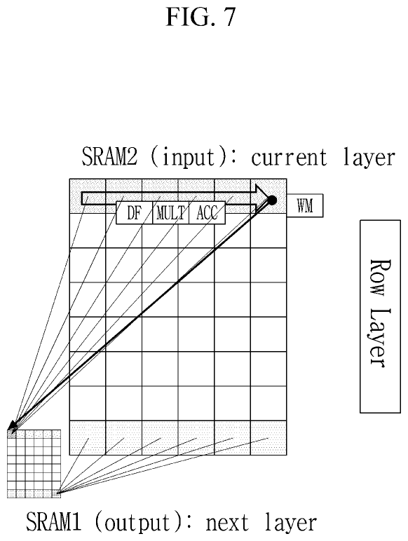

Then, referring to FIG. 7, when the second neural network layer following the first neural network layer corresponds to the row layer, the operator 100, whenever performing the data fetch step, the multiplication step, and the accumulation step M times on the input feature map IFM read from the second memory 112, may perform the write memory step to the first memory 110 once.

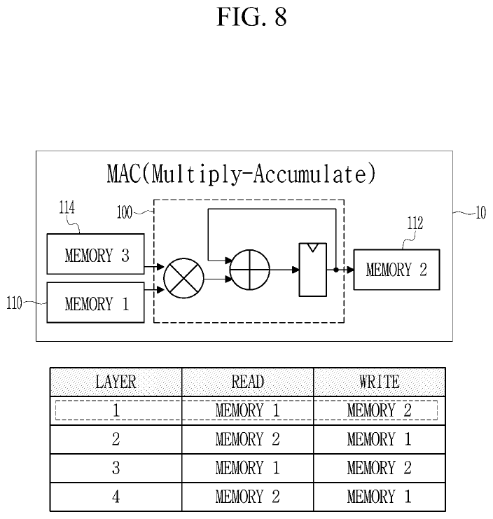

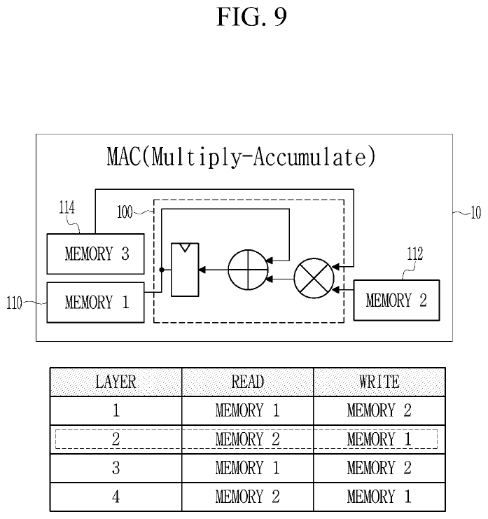

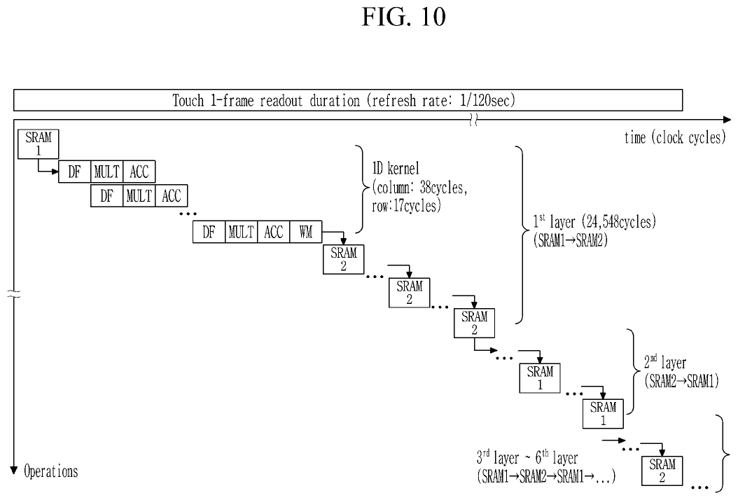

FIG. 8 to FIG. 10 illustrate methods of operating a semiconductor device according to an embodiment.

Referring to FIG. 8 to FIG. 10, a method of operating a semiconductor device according to an embodiment may include: providing feature map data including N rows and M columns to the first memory 110, where N is an integer greater than or equal to two, and M is an integer greater than or equal to two; reading the feature map data stored in the first memory 110 and performing a first artificial intelligence operation on a first column to an M-th column of the feature map data; writing a result of the first artificial intelligence operation to the second memory 112; reading the feature map data stored in the second memory 112 and performing a second artificial intelligence operation on a first row to an N-th row of the feature map data; and writing a result of the second artificial intelligence operation to the first memory 110.

In the present embodiment, in the performing of the first artificial intelligence operation, the data fetch step, the multiplication step, the accumulation step, and the write memory step may be performed using pipelining, and the write memory step may be performed once whenever the data fetch step, the multiplication step, and the accumulation step are performed N times for one column of the first column to the M-th column.

In addition, the performing of the second artificial intelligence operation may include performing a data fetch step, a multiplication step, an accumulation step, and a write memory step using pipelining and performing the write memory step once whenever the data fetch step, the multiplication step, and the accumulation step are performed M times for one row of the first row to the Nth row.

In some embodiments, the method of operating the semiconductor device according to the embodiment may further include performing pre-processing on input data from one or more domains for the first artificial intelligence operation, and providing the pre-processed data to the first memory 110 or the second memory 112.

In addition, in some embodiments, the method of operating the semiconductor device according to the embodiment may further include performing post-processing on output data from the second artificial intelligence operation and providing the post-processed data to one or more domains.

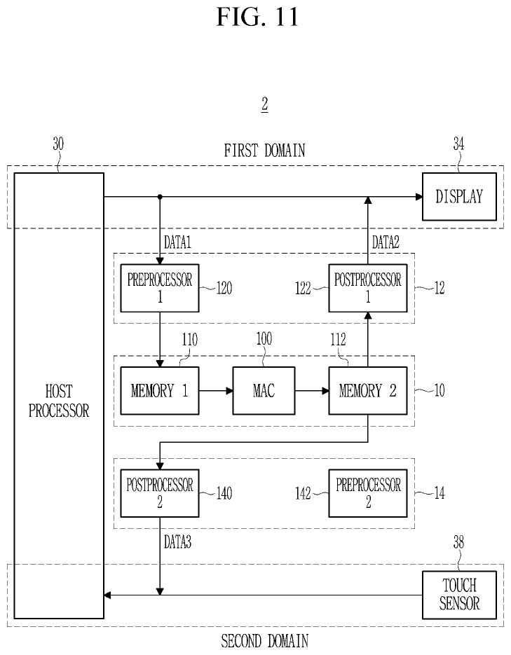

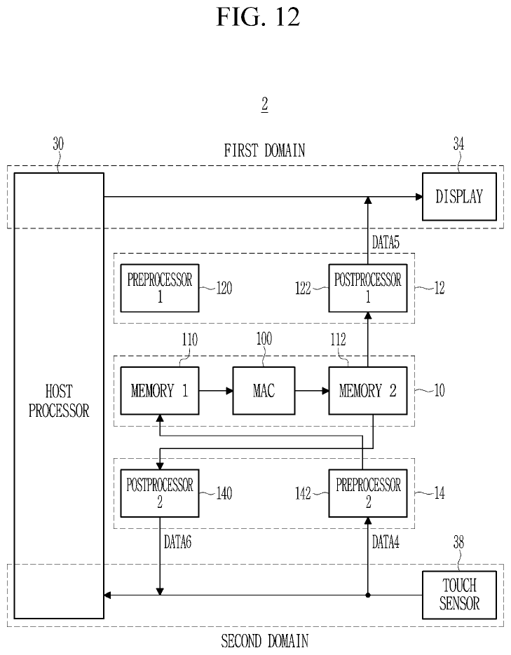

FIG. 11 and FIG. 12 illustrate block diagrams of a semiconductor system according to an embodiment.

Referring to FIG. 11, in a semiconductor system 2 according to the embodiment, the artificial intelligence unit 10 may perform an artificial intelligence operation on data DATA1 of the first domain. Here, the first domain includes a host processor 30 and a display 34, and the data DATA1 of the first domain may be data having a higher resolution and a lower refresh rate than that of the second domain.

The data DATA1 of the first domain may be transmitted to a pre-processor 120, down-sampled for resolution, and then stored in the first memory 110. The operator 100 may perform an artificial intelligence operation on the data stored in the first memory 110 and may store the operation result in the second memory 112. The operator 100 may repeat a process of reading the feature map data stored in the first memory 110 for a first neural network layer, performing an artificial intelligence operation, and storing the operation result in the second memory 112. In some examples, the operator 100 may repeat a process of reading the feature map data stored in the second memory 112 for a second neural network layer following the first neural network layer, performing an artificial intelligence operation, and storing the operation result in the first memory 110.

The data stored in the second memory 112 may be transmitted to a post-processor 122, upscaled, and then provided to the first domain as data DATA2. Alternatively, the data stored in the second memory 112 may be transmitted to the post-processor 140 and provided to the second domain as data DATA3 after an operation of converting a frame rate to a high level is performed.

Referring to FIG. 12, in the semiconductor system 2 according to the embodiment, the artificial intelligence unit 10 may perform an artificial intelligence operation on data DATA4 of the second domain. Here, the second domain includes a host processor 30 and a touch sensor 38, and the data DATA4 of the second domain may be data having a higher resolution and a lower refresh rate than that of the first domain.

The data DATA4 of the second domain may be transmitted to a pre-processor 142, down-sampled for a refresh rate, and then stored in the first memory 110. The operator 100 may perform an artificial intelligence operation on the data stored in the first memory 110 and may store the operation result in the second memory 112. The operator 100 may repeat a process of reading the feature map data stored in the first memory 110 for the first neural network layer, performing an artificial intelligence operation, and storing the operation result in the second memory 112. In some examples, the operator 100 may repeat a process of reading the feature map data stored in the second memory 112 for the second neural network layer following the first neural network layer, performing an artificial intelligence operation, and storing the operation result in the first memory 110.

The data stored in the second memory 112 may be transmitted to a post-processor 122, upscaled, and then provided to the first domain as data DATA5. Alternatively, the data stored in the second memory 112 may be transmitted to the post-processor 140 and provided to the second domain as data DATA6 after an operation of converting a frame rate to a high level is performed.

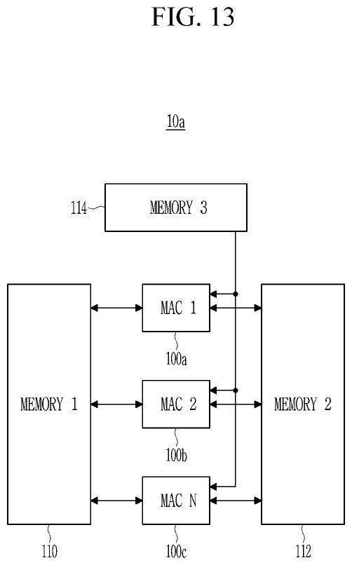

FIG. 13 illustrates a block diagram of a semiconductor device according to an embodiment.

Referring to FIG. 13, an artificial intelligence unit 10a of a semiconductor device according to an embodiment may include a plurality of operators 100a, 100b, and 100c. The plurality of operators 100a, 100b, and 100c may all perform the same artificial intelligence operation, and some of the plurality of operators 100a, 100b, and 100c may perform different artificial intelligence operations.

Specifically, the operator 100 may include a first operator 100a that performs a first artificial intelligence operation and a second operator 100b that performs a second artificial intelligence operation different from the first artificial intelligence operation.

The first operator 100a may use, for a neural network layer, a partial area of the first memory 110 and a partial area of the second memory 112 as a first space for storing data before the first artificial intelligence operation and a second space for storing data after the first artificial intelligence operation, respectively.

The second operator 100b may use, for a neural network layer, another partial area of the first memory 110 and another partial area of the second memory 112 as a first space for storing data before the second artificial intelligence operation and a second space for storing data after the second artificial intelligence operation, respectively.

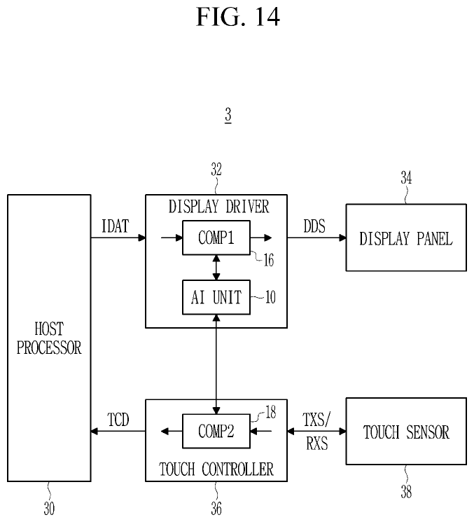

FIG. 14 illustrates a block diagram of a semiconductor system according to an embodiment.

Referring to FIG. 14, a semiconductor system 3 according to an embodiment may include: a display driver 32 for driving a display panel 34 based on input image data IDAT; a touch controller 36 for converting a touch sensing signal RXS received from a touch sensor 38 into touch sensing data TCD; a host processor 30 that provides the input image data IDAT to the display driver 32 and receives the touch sensing data TCD from the touch controller 36; and an artificial intelligence unit 10 that performs an artificial intelligence operation to generate predictive noise data corresponding to the input image data IDAT.

In the present embodiment, the artificial intelligence unit 10 may be installed in the display driver 32. Specifically, the display driver 32 may include the artificial intelligence unit 10 that performs the artificial intelligence operation for generating the predictive noise data corresponding to the input image data IDAT, and the touch controller 36 may include a compensation circuit 18 that compensates the touch sensing data RXS by using the prediction noise data. Meanwhile, the artificial intelligence unit 10 may perform an artificial intelligence operation for generating prediction data corresponding to the touch sensing data RXS, and the artificial intelligence unit 10 may communicate with a compensation circuit 16 that compensates the input image data IDAT by using the corresponding prediction data.

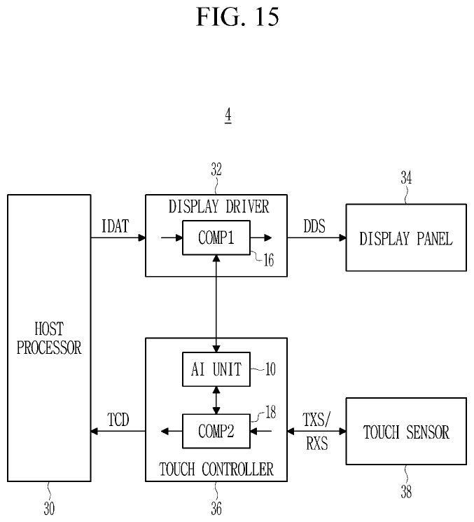

FIG. 15 illustrates a block diagram of a semiconductor system according to an embodiment. For instance, in FIG. 15 (e.g., in a semiconductor system 4 of FIG. 15), the artificial intelligence unit 10 may be installed in the touch controller 36. Specifically, the touch controller 36 may include the artificial intelligence unit 10 that performs the artificial intelligence operation for generating the predictive noise data corresponding to the input image data IDAT and the compensation circuit 18 that compensates the touch sensing data RXS by using the prediction noise data. Meanwhile, the artificial intelligence unit 10 may perform an artificial intelligence operation for generating prediction data corresponding to the touch sensing data RXS, and the display driver 32 may include a compensation circuit 16 that compensates the input image data IDAT by using the corresponding prediction data.

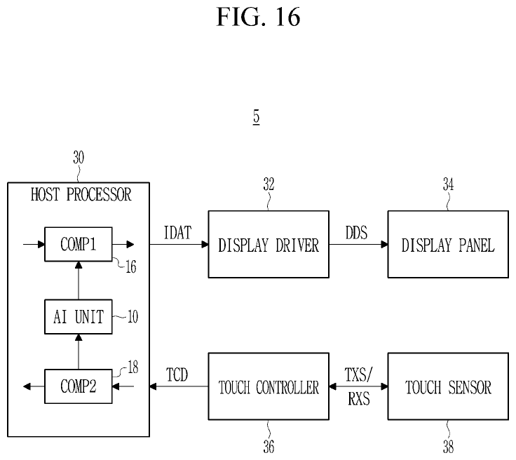

FIG. 16 illustrates a block diagram of a semiconductor system according to an embodiment. For instance, in FIG. 16, the artificial intelligence unit 10 may be installed in the host processor 30. Specifically, the host processor 30 may include the artificial intelligence unit 10 that performs the artificial intelligence operation for generating the predictive noise data corresponding to the input image data IDAT and the compensation circuit 18 that compensates the touch sensing data RXS by using the prediction noise data. Meanwhile, the artificial intelligence unit 10 may perform an artificial intelligence operation for generating prediction data corresponding to the touch sensing data RXS, and the host processor 30 may include a compensation circuit 16 that compensates the input image data IDAT by using the corresponding prediction data.

According to the embodiments described so far, even in a resource-limited environment, artificial intelligence operations may be performed only with minimal hardware configuration without separate software, so that it may be applied to a small integrated circuit IC. In addition, processing is possible even when the domains of input data and output data are different.

While one or more aspects of the present disclosure have been described in connection with what is presently considered to be practical embodiments, it is to be understood that the present disclosure is not limited to the disclosed example embodiments, but, on the contrary, is intended to cover various modifications and equivalent arrangements included within the spirit and scope of the appended claims.

1. A semiconductor device, comprising:
an operator configured to perform an artificial intelligence operation;
a first memory and a second memory each configured to store feature map data used in the artificial intelligence operation; and
a third memory configured to store a training parameter used in the artificial intelligence operation,
wherein the operator uses, for a neural network layer, the first memory and the second memory as a first space for storing data before the artificial intelligence operation and a second space for storing data after the artificial intelligence operation, respectively.

2. The semiconductor device of claim 1, wherein the operator:
reads the feature map data stored in the first memory for a first neural network layer to perform the artificial intelligence operation; and
stores an operation result of the artificial intelligence operation in the second memory.

3. The semiconductor device of claim 2, wherein the operator:
reads the feature map data stored in the second memory for a second neural network layer following the first neural network layer to perform the artificial intelligence operation; and
stores an operation result of the artificial intelligence operation in the first memory.

4. The semiconductor device of claim 1, wherein the operator:
divides the artificial intelligence operation into a data fetch step, a multiplication step, an accumulation step, and a write memory step; and
performs the data fetch step, the multiplication step, the accumulation step, and the write memory step using pipelining.

5. The semiconductor device of claim 4, wherein
when the feature map data includes N rows and M columns, and when the neural network layer corresponds to a column layer, the operator performs the write memory step once whenever performing the data fetch step, the multiplication step, and the accumulation step N times, wherein N is an integer greater than or equal to two, and M is an integer greater than or equal to two.

6. The semiconductor device of claim 4, wherein
when the feature map data includes N rows and M columns, and when the neural network layer corresponds to a row layer, the operator performs the write memory step once whenever performing the data fetch step, the multiplication step, and the accumulation step M times, wherein N is an integer greater than or equal to two, and M is an integer greater than or equal to two.

7. The semiconductor device of claim 1, further comprising
a pre-processor configured to perform pre-processing on input data from one or more domains for the artificial intelligence operation and provide the pre-processed data to the first memory or the second memory.

8. The semiconductor device of claim 1, further comprising
a post-processor configured to perform post-processing on output data from the artificial intelligence operation and provide the post-processed data to one or more domains.

9. The semiconductor device of claim 1, wherein
the operator includes a first operator that performs a first artificial intelligence operation and a second operator that performs a second artificial intelligence operation different from the first artificial intelligence operation, and
the first operator uses, for the neural network layer, a partial area of the first memory and a partial area of the second memory as a third space for storing data before the first artificial intelligence operation and a fourth space for storing data after the first artificial intelligence operation, respectively.

10. The semiconductor device of claim 9, wherein
the second operator uses, for the neural network layer, another partial area of the first memory and another partial area of the second memory as a fifth space for storing data before the second artificial intelligence operation and a sixth space for storing data after the second artificial intelligence operation.

11.-15. (canceled)

16. A semiconductor system, comprising:
a display driver configured to drive a display panel based on input image data;
a touch controller configured to convert a touch sensing signal received from a touch sensor into touch sensing data;
a host processor configured to provide the input image data to the display driver and receives the touch sensing data from the touch controller; and
an artificial intelligence unit configured to perform an artificial intelligence operation generating predictive noise data corresponding to the input image data,
wherein the artificial intelligence unit includes:
an operator configured to perform the artificial intelligence operation;
a first memory and a second memory each configured to store feature map data used in the artificial intelligence operation; and
a third memory configured to store a training parameter used in the artificial intelligence operation, and
the operator uses, for a neural network layer, the first memory and the second memory as a first space for storing data before the artificial intelligence operation and a second space for storing data after the artificial intelligence operation, respectively.

17. The semiconductor system device of claim 16, wherein
the artificial intelligence unit is installed in one of the display driver, the touch controller, and the host processor.

18. The semiconductor system of claim 16, wherein the operator:
divides the artificial intelligence operation into a data fetch step, a multiplication step, an accumulation step, and a write memory step; and
performs the data fetch step, the multiplication step, the accumulation step, and the write memory step using pipelining.

19. The semiconductor system of claim 18, wherein
when the feature map data includes N rows and M columns, and when the neural network layer corresponds to a column layer, the operator performs the write memory step once whenever performing the data fetch step, the multiplication step, and the accumulation step N times, wherein N is an integer greater than or equal to two, and M is an integer greater than or equal to two.

20. The semiconductor system of claim 18, wherein
when the feature map data includes N rows and M columns, and when the neural network layer corresponds to a row layer, the operator performs the write memory step once whenever performing the data fetch step, the multiplication step, and the accumulation step M times, wherein N is an integer greater than or equal to two, and M is an integer greater than or equal to two.

21.-22. (canceled)

23. A semiconductor system, comprising:
a first device and a second device that exchange data in a first domain;
a third device and a fourth device that exchange data in a second domain different from the first domain;
an artificial intelligence unit that performs an artificial intelligence operation on data in the first domain or data in the second domain;
a first pre/post-processor that performs first pre-processing to provide the data of the first domain to the artificial intelligence unit or that performs first post-processing to provide an operation result of the artificial intelligence unit to the first domain; and
a second pre/post-processor that performs second pre-processing to provide the data of the second domain to the artificial intelligence unit or that performs second post-processing to provide an operation result of the artificial intelligence unit to the second domain.

24. The semiconductor system of claim 23, wherein
the artificial intelligence unit includes:
an operator performing the artificial intelligence operation;
a first memory and a second memory that store feature map data used in the artificial intelligence operation; and
a third memory that stores a training parameter used in the artificial intelligence operation, wherein
the operator uses, for a neural network layer, the first memory and the second memory as a first space for storing data before the artificial intelligence operation and a second space for storing data after the artificial intelligence operation, respectively.

25. The semiconductor system of claim 23, wherein the operator:
divides the artificial intelligence operation into a data fetch step, a multiplication step, an accumulation step, and a write memory step; and
performs the data fetch step, the multiplication step, the accumulation step, and the write memory step using pipelining.

26. The semiconductor system of claim 25, wherein
when the feature map data includes N rows and M columns, and when the neural network layer corresponds to a column layer, the operator performs the write memory step once whenever performing the data fetch step, the multiplication step, and the accumulation step N times, wherein N is an integer greater than or equal to two, and M is an integer greater than or equal to two.

27. The semiconductor system of claim 25, wherein
when the feature map data includes N rows and M columns, and when the neural network layer corresponds to a row layer, the operator performs the write memory step once whenever performing the data fetch step, the multiplication step, and the accumulation step M times, wherein N is an integer greater than or equal to two, and M is an integer greater than or equal to two.

28.-30. (canceled)
